(19) United States
(12) Patent Application Publication
(10) Pub. No.: US 2024/0316515 A1
(43) Pub. Date: Sep. 26, 2024

(54) SYSTEMS AND METHODS FOR PRODUCING ONE OR MORE POWDERS EACH FORMED OF TWO OR MORE MATERIALS

(71) Applicant: GM GLOBAL TECHNOLOGY OPERATIONS LLC, Detroit, MI (US)

(72) Inventors: Ronald C. Daul, Northville, MI (US); Ali Shabbir, Sterling Heights, MI (US); Qigui Wang, Rochester Hills, MI (US)

(73) Assignee: GM GLOBAL TECHNOLOGY OPERATIONS LLC, Detroit, MI (US)

(21) Appl. No.: 18/187,195

(22) Filed: Mar. 21, 2023

(51) Int. Cl. B01J 2/02; B01J 8/42

(52) U.S. Cl. CPC B01J 2/02; B01J 8/42; B01J 2208/00017; B01J 2208/00672; B01J 2208/00884

(57) ABSTRACT

Systems and methods are provided for producing one or more powders each formed of two or more materials. The system includes a housing having an enclosure, a crucible configured to produce a melt of a first material, a droplet device configured to receive the melt of the first material and produce a flow of droplets thereof within the enclosure, a distribution device configured to propel a second material into the droplets to mix therewith, wherein the droplets solidify to form particles of the first material, the second material, and/or a reaction product thereof, a platform within the enclosure configured to intercept the particles, and one or more generators configured to produce electromagnetic waves and/or acoustic waves to form a fluidized bed of the particles on the platform. The platform and/or the one or more generators are configured to produce, from the fluidized bed, a powder including the particles.

### INTRODUCTION

The technical field generally relates to powder production, and more particularly relates to systems and method for producing one or more powders each formed of or including two or more materials.

Additive manufacturing (AM) processes, such as laser powder bed fusion (LPBF), have recently come to prominence as a cost-effective alternative to various other manufacturing techniques. Additive manufacturing is the process of joining materials to make objects from 3D model data, usually layer upon layer, as opposed to subtractive manufacturing methodologies, such as machining and casting. Additive manufacturing produces sequential layers from a build material, typically a powder or wire feedstock. Due in part to the growing prevalence of additive manufacturing, powders having highly uniform compositions and/or mixtures are becoming increasingly desirable.

Accordingly, it is desirable to provide systems and methods capable of producing highly uniform powders for applications such as additive manufacturing. Furthermore, other desirable features and characteristics of the present invention will become apparent from the subsequent detailed description and the appended claims, taken in conjunction with the accompanying drawings and the foregoing technical field and background.

### SUMMARY

A system is provided for producing a powder. In one embodiment, the system includes a housing having an enclosure, a crucible configured to produce a melt of a first material, a droplet device configured to receive the melt of the first material from the crucible and produce a flow of droplets of the melt of the first material within the enclosure of the housing, a distribution device configured to propel a second material into the flow of droplets of the first material within the enclosure such that the second material is mixed with the flow of droplets of the first material, wherein the droplets solidify in the enclosure to form particles of the first material, the second material, and/or a reaction product thereof, a platform within the enclosure configured to intercept the particles, and one or more generators configured to produce electromagnetic waves and/or acoustic waves to form a fluidized bed of the particles on the platform. The platform and/or the one or more generators are configured to produce, from the fluidized bed, the powder that includes the particles.

In various embodiments, the particles of the powder include an alloy of the first material and the second material.

In various embodiments, the particles of the powder include a core formed of the first material and a coating or layer of the second material thereon.

In various embodiments, the powder includes a mixture of particles of the first material and the second material.

In various embodiments, the droplet device is configured to apply an electrostatic charge to the first material and/or the distribution device is configured to apply an electrostatic charge to the second material.

In various embodiments, the powder is a first powder, wherein the one or more generators are configured to control the fluidized bed to produce the first powder and a second powder simultaneously, wherein the second powder is separate and different from the first powder. In various embodiments, the first powder and the second powder have different particle size ranges, sphericity ranges, and/or mixture ratios.

In various embodiments, the one or more generators are configured to control the fluidized bed to produce the powder with a predetermined volume or mass fraction of the first material, the second material, and/or the reaction product thereof.

In various embodiments, the one or more generators are configured to control the fluidized bed to produce the powder with a predetermined particle size distribution.

In various embodiments, the system includes a second distribution device configured to propel a third material into the flow of droplets of the first material within the enclosure such that the third material is mixed with the droplets of the first material.

A method is provided for producing a powder. In one embodiment, the method includes increasing a temperature of a first material sufficient to produce a melt thereof, producing a flow of droplets of the melt of the first material within an enclosure of a housing, propelling a second material into the flow of droplets of the first material within the enclosure such that the second material is mixed with the droplets of the first material, solidifying the droplets within the enclosure to form particles of the first material, the second material, and/or a reaction product thereof, fluidizing the particles via application of electromagnetic waves and/or acoustic waves to form a fluidized bed, and collecting the powder that includes the particles.

In various embodiments, the particles of the powder include an alloy of the first material and the second material.

In various embodiments, the particles of the powder include a core formed of the first material and a coating or layer of the second material thereon.

In various embodiments, the powder includes a mixture of particles of the first material and the second material.

In various embodiments, the method includes applying an electrostatic charge to the first material and/or the second material prior to contact therebetween.

In various embodiments, the powder is a first powder and the method includes controlling the fluidized bed to produce the first powder and a second powder simultaneously, wherein the second powder is separate and different from the first powder. In various embodiments, the first powder and the second powder have different particle size ranges, sphericity ranges, and/or mixture ratios.

In various embodiments, the method includes controlling the fluidized bed to produce the powder with a predetermined volume or mass fraction of the first material, the second material, and/or the reaction product thereof.

In various embodiments, the method includes controlling the fluidized bed to produce the powder with a predetermined particle size distribution.

In various embodiments, the method includes propelling a third material into the flow of droplets of the first material within the enclosure such that the third material is mixed with the droplets of the first material.

### BRIEF DESCRIPTION OF THE DRAWINGS

The exemplary embodiments will hereinafter be described in conjunction with the following drawing figures, wherein like numerals denote like elements, and wherein:

FIG. 1 is diagram of a system for producing powder in accordance with an embodiment; and

FIG. 2 is flowchart illustrating a method of producing a powder in accordance with an embodiment.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description.

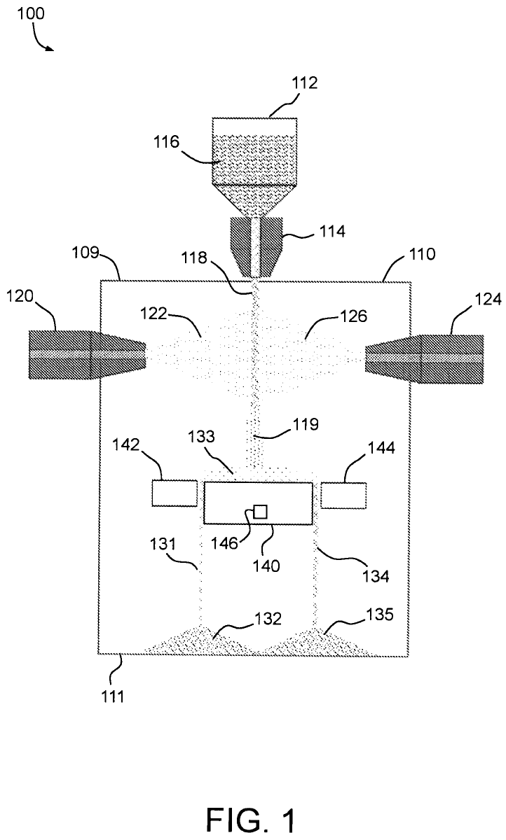

FIG. 1 presents an exemplary system 100 for producing various types of powders that include two or more materials having different compositions. The system 100 includes a housing 110 having walls that in combination define an enclosure therebetween. The housing 110 is not limited to any particular shape. In some embodiments, the housing 110 may be rectangular or cylindrical.

A crucible 112 is provided that is configured to receive a first material 116 from a source thereof and increase the temperature of the first material 116 sufficient to produce a melt of the first material 116. The crucible 112 may be any type of crucible using any type of heating element (e.g., electric resistance) configured to increase the temperature of the first material 116 sufficient to form the melt. In the embodiment of FIG. 1, the crucible 112 includes a funnel configured to direct the melt by gravity to an outlet of the crucible 112.

The melt may be directed from the crucible 112 to a droplet device 114. The droplet device 114 may be any type of device configured to receive the melt from the crucible 112, produce therefrom a flow of droplets 118 of the melt, and expel the droplets 118 into the enclosure of the housing 110. Nonlimiting examples of droplet devices 114 may include, but are not limited to, various atomizer devices, electromagnetic devices, etc. In various embodiments, the droplet device 114 may be configured to produce more than one stream of droplets 118 expelled therefrom. In various embodiments, the droplet device 114 may be configured to produce a shower of droplets 118 of the melt. In the embodiment of FIG. 1, the droplets 118 freefall through the enclosure from an outlet of the droplet device 114. Alternatively, the droplets 118 may be sprayed or otherwise propelled into the enclosure by the droplet device 114.

One or more distribution devices may be provided to propel additional materials into the enclosure to contact, react with, and/or mix with the droplets 118 of the first material 116 therein. In the embodiment of FIG. 1, the system 100 includes a first distribution device 120 configured to propel (e.g., spray) a second material 122 and a second distribution device 124 configured to propel a third material 126. Nonlimiting examples of distribution devices 120 and 124 may include, but are not limited to, various pressurized spray nozzles, mechanical throwing devices (e.g., spinning wheel), etc. Although the first distribution device 120 and the second distribution device 124 are represented as propelling the second material 122 and the third material 126, respectively, in directions perpendicular to the flow of droplets 118 and opposite each other, other arrangements may be provided. For example, the additional materials may be propelled at different angles relative to the travel path of the droplets 118 (e.g., 1 to 89 degrees), at different angles relative to each other, and/or to contact the droplets 118 at different positions (relative to a distance traveled by the droplets 118 and/or relative to each other). The propelled second material 122 and third material 126 mix with the droplets 118 to produce a stream 119 of the first material 116, the second material 122, and the third material 126 which continues to travel toward the lower end 111 of the housing 110.

The droplets 118 cool and solidify within the enclosure to form particles. Preferably, the droplets 118 solidify during flight thereof prior to contacting surfaces of the housing 110 or any components therein. The system 100 may be configured such that the droplets 118 solidify prior to contacting, reacting, and/or mixing with the second material 122 and the third material 126, subsequent to contacting, reacting, and/or mixing with the second material 122 and the third material 126, or prior to contacting, reacting, and/or mixing with either of the second material 122 and the third material 126 and subsequent to contacting, reacting, and/or mixing with the other of the second material 122 and the third material 126. The second material 122 and the third material 126 may include solid particles, liquid droplets, or a combination thereof.

In various embodiments, the droplet device 114, the first distribution device 120, and/or the second distribution device 124 may be configured to apply an electrostatic charge to the first material 116, the second material 122, and/or the third material 126, respectively. In such embodiments, the electrostatic charge may be configured to produce or intensify attractions between the first material 116, the second material 122, and/or the third material 126. Various devices and methods known in the art may be used to apply the electrostatic charge(s).

A platform 140 is located within the housing 110 and configured to intercept and contact the stream 119 of the first material 116, the second material 122, the third material 126, combinations thereof, and/or reaction products thereof. In various embodiments, the platform 140 and/or other components of the system 100 are configured to fluidize powders that accumulate on the platform 140 from the stream 119. Various methods may be used to fluidize the powders and produce a fluidized bed 133.

In various embodiments, application of electromagnetic waves and/or acoustic waves result in the formation of the fluidized bed 133. In various embodiments, the fluidized bed 133 is formed and/or controlled, at least in part, by application of one or more electromagnetic fields. In various embodiments, the fluidized bed 133 is formed and/or controlled, at least in part, by application of ultrasonic vibrations. In various embodiments, the fluidized bed 133 is formed and/or controlled, at least in part, by application of acoustic waves. In such embodiments, properties of the fluidized bed 133 may be modified by, for example, applying the electromagnetic waves and/or acoustic waves at various intensities, at various frequencies, and/or for various lengths of time (e.g., pulsing, continuous, etc.).

In various embodiments, the fluidized bed 133 is configured to delay the fall of the particles therein while simultaneously increasing contact between and/or mixing of the particles. In various embodiments, the fluidized bed 133 is configured to fluidize particles with particle sizes ranging from a few micrometers to at least 100 micrometers in diameter. Subsequent to processing in the fluidized bed 133, the particles may fall from the platform 140 in one or more paths or passages adjacent sides of the platform 140. For example, FIG. 1 represents the particles as falling from the platform 140 in either a first stream 131 or a second stream 134. Although the embodiment represented in FIG. 1 includes only one fluidized bed 133 and a pair of passages for the particles exiting the fluidized bed 133, in various embodiments the system 100 may include more than one fluidized bed 133 and/or fewer or more passages therefrom.

With such arrangements, the system 100 may be configured to produce one or more separate and different powders, such as a first powder 132 accumulating from the first stream 131 and a second powder 135 accumulating from the second stream 134. Each of the powders 132 and 135 may have different particle size ranges, sphericity ranges, mixture ratios, etc. In various embodiments, the fluidized bed 133 is configured to control particle sizes of the powders 132 and/or 135 to a range typical to additively manufacturing (AM) processes such as, for example, about 10 to 50 micrometers (μm).

The fluidized bed 133 may be controlled to achieve one or more intended purposes. In various embodiments, one, two, or more of the powders within the fluidized bed 133 may be selectively and actively controlled based on a unique resonant frequency (driven by density and/or particle mass) of each of the powders. In various embodiments, the fluidized bed 133 may be controlled to accelerate intermixing of the particles during fluidization to promote rapid production of powder having a homogenous mixture. In various embodiments, the fluidized bed 133 may be controlled to actively control the volume or mass fraction of particles within the produced powders 132 and/or 135. In various embodiments, the fluidized bed 133 may be controlled to actively control the particle size distribution of one or both of the powders 132 and 135. For example, acoustic waves may be applied with certain frequency ranges to cause resonance for only a narrow range of particle sizes (e.g., diameters) due to particle mass. These resonating particles may “sink” to a lower end of the fluidized bed 133 or “rise” to an upper end of the fluidized bed 133 where extraction could be achieved. In various embodiments, the fluidized bed 133 may be controlled to produce various patterns of movement of the powders on the platform 140 such that, for example, powders having specific characteristics are directed toward corresponding paths or passages from the platform 140.

The electromagnetic waves and/or acoustic waves may be produced in various manners. In various embodiments, the platform 140 may include one or more electromagnetic wave generators or acoustic wave generators, for example, within or below the platform 140. In various embodiments, one or more electromagnetic wave generators or acoustic wave generators may be located within the housing 110 and separate from the platform 140. As a nonlimiting example, FIG. 1 represents an embodiment wherein a first electromagnetic wave generator 142 is located adjacent and spaced apart from a first side of the platform 140 and a second electromagnetic wave generator 144 is located adjacent and spaced apart from a second side of the platform 140. The first and second electromagnetic wave generators 142 and 144 may be configured to apply attraction forces and/or repulsion forces to particles within the fluidized bed 133 such that the first powder 132 is directed to the first passage to form the stream 131 and the second powder 135 is directed to the second passage to form the stream 134. In addition, the represented embodiment includes an acoustic wave generator 146 within a body of the platform 140 configured to produce, for example, ultrasonic vibrations at surfaces of the platform 140 to promote formation of the fluidized bed 133.

The first material 116, the second material 122, and the third material 126, and the powders 132 and 135 formed therefrom may include various materials including certain polymeric, metallic, ceramic, and composite materials. In various embodiments, the first material 116 is a metallic material, at least one of the second material 122 and the third material 126 is an alloying element, and the powders 132 and 135 include an alloy of the first material 116 and the second material 122 and/or the third material 126. In various embodiments, the first material 116 is a metallic material, at least one of the second material 122 and the third material 126 is a melt treatment agent (e.g., grain refiners), and the powders 132 and 135 include a combination of the first material 116 and the second material 122 and/or the third material 126. In various embodiments, the first material 116 is a polymeric or metallic material, at least one of the second material 122 and the third material 126 includes distinct particles of a polymeric, metallic, ceramic, or composite material that does not react or combine with the first material 116, and the powders 132 and 135 includes particles having a core formed of the first material 116 and a coating or a layer of particles of the second material 122 and/or the third material 126 thereon. In various embodiments, the first material 116 is a polymeric or metallic material, at least one of the second material 122 and the third material 126 includes distinct particles of a polymeric, metallic, ceramic, or composite material that do not react or combine with the first material 116, and the powders 132 and 135 include a mixture of particles of the first material 116, the second material 122, and/or the third material 126. In various embodiments, the powders 132 and 135 include a nickel-, iron-, cobalt-, copper-, titanium-, and/or aluminum-based alloy. In various embodiments, the powders 132 and 135 include acrylonitrile butadiene styrene (ABS), polylactide (PLA), polycarbonate (PC), polyamide (nylon), an epoxy resin, a wax, and/or a photopolymer resin. In various embodiments, the first material 116 includes aluminum or an alloy thereof or iron or an alloy thereof, and the second and third materials 122 and 126 include grain refinement agents, eutectic modifiers, oxygen removing elements, or various composite particles.

The powders 132 and 135 may include particles having various particle sizes, including submicron particles sizes. In various embodiments, the particles of the powders 132 and 135 may have particles sizes of between about 10 to 300 micrometers (μm), such as between about 10 to 100 μm, between about 10 to 50 μm, and between about 15 to 20 μm. In various embodiments, the powders 132 and 135 have a powder sphericity of greater than 0.7, such as about 0.75 to 0.85, such as about 0.8.

The powders 132 and 135 may be configured for use in various applications. In some embodiments, the powders 132 and 135 are configured for use as a build material in an additive manufacturing process. As used herein, the term additive manufacturing refers to any process wherein thin successive layers of material are laid down atop one another to form an article. Some examples of additive layer manufacturing processes include laser powder bed fusion, binder jetting, directed energy deposition, and electron beam powder bed fusion. Other additive manufacturing processes may also be employed.

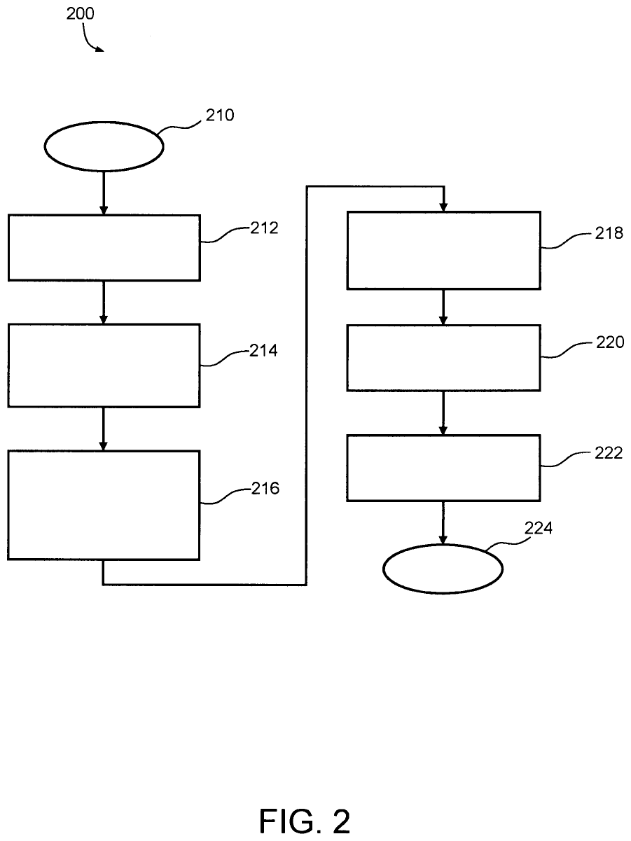

With reference now to FIG. 2 a flowchart provides a method 200 for producing a powder as performed by the system 100, in accordance with exemplary embodiments. As can be appreciated in light of the disclosure, the order of operation within the method 200 is not limited to the sequential execution as illustrated in FIG. 2, but may be performed in one or more varying orders as applicable and in accordance with the present disclosure.

In one example, the method 200 may start at 210. At 212, the method 200 may include increasing a temperature of a first material sufficient to produce a melt thereof. At 214, the method 200 may include producing a flow of droplets of the melt of the first material within an enclosure of a housing. At 216, the method 200 may include propelling a second material into the flow of droplets of the first material within the enclosure such that the second material is mixed with the droplets of the first material to produce a stream of the first material and the second material. Optionally, the method 200 may include propelling one or more additional materials into the flow of droplets of the first material within the enclosure such that the additional material(s) are mixed with the droplets of the first material. At 218, the method 200 may include allowing the droplets of the melt to solidify within the enclosure to form particles. At 220, the method 200 may include fluidizing the solid particles in a fluidized bed. At 222, the method 200 may include collecting a powder that includes the particles. The method 200 may end at 224.

The systems and methods disclosed herein, including the system 100 and the method 200, provide various benefits. Combining the various materials in the manner described herein (e.g., during free fall and/or within a fluidized bed) promotes high levels of contact and collision between gases, liquids, and solids for uniform mixing, homogenization, and potentially high-volume production. Furthermore, the system 100 and the method 200 are capable of producing powders from two or more types of materials. This can allow for control over composition and microstructure. For example, grain refiner agents may be mixed with metallic particles to promote uniform equiaxed grain structures that, for example, do not include columnar grains, which can significantly reduce material mechanical properties (e.g., tensile and fatigue strengths).

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A system for producing a powder, the system comprising:
a housing having an enclosure;
a crucible configured to produce a melt of a first material;
a droplet device configured to receive the melt of the first material from the crucible and produce a flow of droplets of the melt of the first material within the enclosure of the housing;
a distribution device configured to propel a second material into the flow of droplets of the first material within the enclosure such that the second material is mixed with the flow of droplets of the first material, wherein the droplets solidify in the enclosure to form particles of the first material, the second material, and/or a reaction product thereof;
a platform within the enclosure configured to intercept the particles; and
one or more generators configured to produce electromagnetic waves and/or acoustic waves to form a fluidized bed of the particles on the platform,
wherein the platform and/or the one or more generators are configured to produce, from the fluidized bed, the powder that includes the particles.

2. The system of claim 1, wherein the particles of the powder include an alloy of the first material and the second material.

3. The system of claim 1, wherein the particles of the powder include a core formed of the first material and a coating or layer of the second material thereon.

4. The system of claim 1, wherein the powder includes a mixture of particles of the first material and the second material.

5. The system of claim 1, wherein the droplet device is configured to apply an electrostatic charge to the first material and/or the distribution device is configured to apply an electrostatic charge to the second material.

6. The system of claim 1, wherein the powder is a first powder, wherein the one or more generators are configured to control the fluidized bed to produce the first powder and a second powder simultaneously, wherein the second powder is separate and different from the first powder.

7. The system of claim 6, wherein the first powder and the second powder have different particle size ranges, sphericity ranges, and/or mixture ratios.

8. The system of claim 1, wherein the one or more generators are configured to control the fluidized bed to produce the powder with a predetermined volume or mass fraction of the first material, the second material, and/or the reaction product thereof.

9. The system of claim 1, wherein the one or more generators are configured to control the fluidized bed to produce the powder with a predetermined particle size distribution.

10. The system of claim 1, further comprising a second distribution device configured to propel a third material into the flow of droplets of the first material within the enclosure such that the third material is mixed with the droplets of the first material.

11. A method for producing a powder, the method comprising:
increasing a temperature of a first material sufficient to produce a melt thereof;
producing a flow of droplets of the melt of the first material within an enclosure of a housing;
propelling a second material into the flow of droplets of the first material within the enclosure such that the second material is mixed with the droplets of the first material;
solidifying the droplets within the enclosure to form particles of the first material, the second material, and/or a reaction product thereof;
fluidizing the particles via application of electromagnetic waves and/or acoustic waves to form a fluidized bed; and
collecting the powder that includes the particles.

12. The method of claim 11, wherein the particles of the powder include an alloy of the first material and the second material.

13. The method of claim 11, wherein the particles of the powder include a core formed of the first material and a coating or layer of the second material thereon.

14. The method of claim 11, wherein the powder includes a mixture of particles of the first material and the second material.

15. The method of claim 11, further comprising applying an electrostatic charge to the first material and/or the second material prior to contact therebetween.

16. The method of claim 11, wherein the powder is a first powder and the method comprises controlling the fluidized bed to produce the first powder and a second powder simultaneously, wherein the second powder is separate and different from the first powder.

17. The method of claim 16, wherein the first powder and the second powder have different particle size ranges, sphericity ranges, and/or mixture ratios.

18. The method of claim 11, further comprising controlling the fluidized bed to produce the powder with a predetermined volume or mass fraction of the first material, the second material, and/or the reaction product thereof.

19. The method of claim 11, further comprising controlling the fluidized bed to produce the powder with a predetermined particle size distribution.

20. The method of claim 11, further comprising propelling a third material into the flow of droplets of the first material within the enclosure such that the third material is mixed with the droplets of the first material.
